(19) United States
(12) Patent Application Publication
(10) Pub. No.: US 2006/0149666 A1
(43) Pub. Date: Jul. 6, 2006

(54) Method and system for originating loans

(76) Inventor: John J. Mesich JR., Cedarburg, WI (US)

Correspondence Address: MICHAEL BEST & FRIEDRICH, LLP, 100 E WISCONSIN AVENUE, MILWAUKEE, WI, 53202, US

(21) Appl. No.: 11/324,077

(22) Filed: Dec. 30, 2005

Related U.S. Application Data
(60) Provisional application No. 60/640,683, filed on Dec. 31, 2004.

(51) Int. Cl. G06Q 40/00

(52) U.S. Cl. 705/38

(57) ABSTRACT

A method of originating a loan. In one embodiment, the method includes establishing a legally binding agreement between a real estate agent and a mortgage company. The agreement has a set of terms which include establishing the real estate agent as an independent contractor; obligating the real estate agent to communicate with an agent of the mortgage company; obligating the real estate agent to disclose the relationship with the mortgage company to a prospective buyer; and establishing a compensation of the real estate agent by the mortgage company. The real estate agent must also disclose the relationship between the real estate agent and the mortgage company to a prospective buyer.

### CROSS REFERENCE TO RELATED APPLICATIONS

This application claims priority to U.S. Provisional Application No. 60/640,683, filed Dec. 31, 2004, Attorney Docket No. 065581-9002-00, the entire contents of which are incorporated herein by reference.

### BACKGROUND

Embodiments of the invention relate to a method and a system for originating loans.

The process of applying for, obtaining, and paying back a mortgage loan is one known to millions of adults. While computerization and the Internet have changed the process in certain ways, many of the basic aspects have remained unchanged since individuals first started borrowing money to purchase homes and other real estate.

Part of a typical process may involve a potential buyer working with a real estate agent to find a property that meets the buyer's requirements. After finding the property, the buyer then applies for a loan from a bank or other mortgage lender. The lender assesses the buyer to ensure that he or she meets certain criteria. If so, the bank approves the loan. Once the loan is approved, the purchase may ensue. The appropriate funds are provided to the seller, and the buyer takes possession of the real estate. Typically, the real estate agent has relatively little involvement in helping the buyer secure a loan, other than perhaps suggesting to the buyer that certain lenders may be interested in lending the buyer funds.

### SUMMARY

Embodiments of the invention provide methods and systems whereby real estate agents may have a more active role in assisting buyers in obtaining appropriate financing. The following summary sets forth certain embodiments of such methods and systems. However, it does not set forth all such embodiments and should in no way be construed as limiting of any particular embodiment.

One embodiment includes a method of originating a loan. The method may include, among other things, establishing a legally binding agreement between a real estate agent and a mortgage company to establish the real estate agent as an eternal loan originator, wherein the agreement has a set of terms. The set of terms can include establishing the external loan originator as an independent contractor; obligating the external loan originator to communicate with an agent of the mortgage company; obligating the external loan originator to disclose the relationship with the mortgage company to a prospective buyer; and establishing a compensation of the external loan originator by the mortgage company. The method of originating the loan also includes obtaining, if required by law for the external loan originator, a Federal or State loan originator license. After the license has been obtained the external loan originator contacts a prospective buyer. The external loan originator discloses the relationship with the mortgage company to the prospective buyer prior to completing a pre-approval application. The pre-approval application includes information sufficient to generate an initial assessment of the prospective buyer's credit worthiness, but which excludes specific loan terms. The external loan originator is compensated upon consummation of the loan pursuant to the terms of the agreement.

In another embodiment a method of originating a loan includes establishing a legally binding agreement with an external licensed loan originator. The agreement has a set of terms that include establishing the external loan originator as an independent contractor; obligating the external loan originator to disclose the agreement to a prospective buyer; and establishing a compensation of the external loan originator. The method of originating the loan can also include receiving a pre-approval application from the external loan originator. The pre-approval application includes information sufficient to generate an initial assessment of the prospective buyer's credit worthiness, but which excludes specific loan terms. Additionally, compensation is dispersed upon consummation of the loan pursuant to the terms of the agreement.

In yet another embodiment a method of originating a loan includes becoming a licensed external loan originator with a bank. An agreement is also established with the bank, and the agreement has a set of terms. The set of terms can include becoming an independent contractor with respect to the bank; communicating with an agent of the mortgage company; and establishing a compensation amount by the mortgage company. Additionally, the method of originating the loan includes obtaining, if required by law, a Federal or State loan originator license; disclosing a relationship with the bank with a prospective buyer; and completing a pre-approval application. The pre-approval application can include information sufficient to generate an initial assessment of the prospective buyer's credit worthiness, but which excludes specific loan terms. Upon consummation of the loan pursuant to the terms of the agreement, compensation is received.

Other embodiments will become apparent to those skilled in the art upon review of the following detailed description and drawings.

### BRIEF DESCRIPTION OF THE DRAWINGS

FIG. 1 is a schematic diagram of a system according to one embodiment of the invention.

FIG. 2A illustrates a first portion of a flow chart of processes carried out in certain embodiments of the invention.

FIG. 2B illustrates a second portion of a flow chart of processes carried out in certain embodiments of the invention.

FIG. 3A illustrates a first portion of an exemplary agreement between a lender and a real estate agent.

FIG. 3B illustrates a second portion of the exemplary agreement of FIG. 3A.

FIG. 3C illustrates a third portion of the exemplary agreement of FIG. 3A.

FIG. 3D illustrates a fourth portion of the exemplary agreement of FIG. 3A.

FIG. 3E illustrates a fifth portion of the exemplary agreement of FIG. 3A.

FIG. 4 illustrates an exemplary relationship disclosure form.

FIG. 5 illustrates an exemplary pre-approval loan form.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

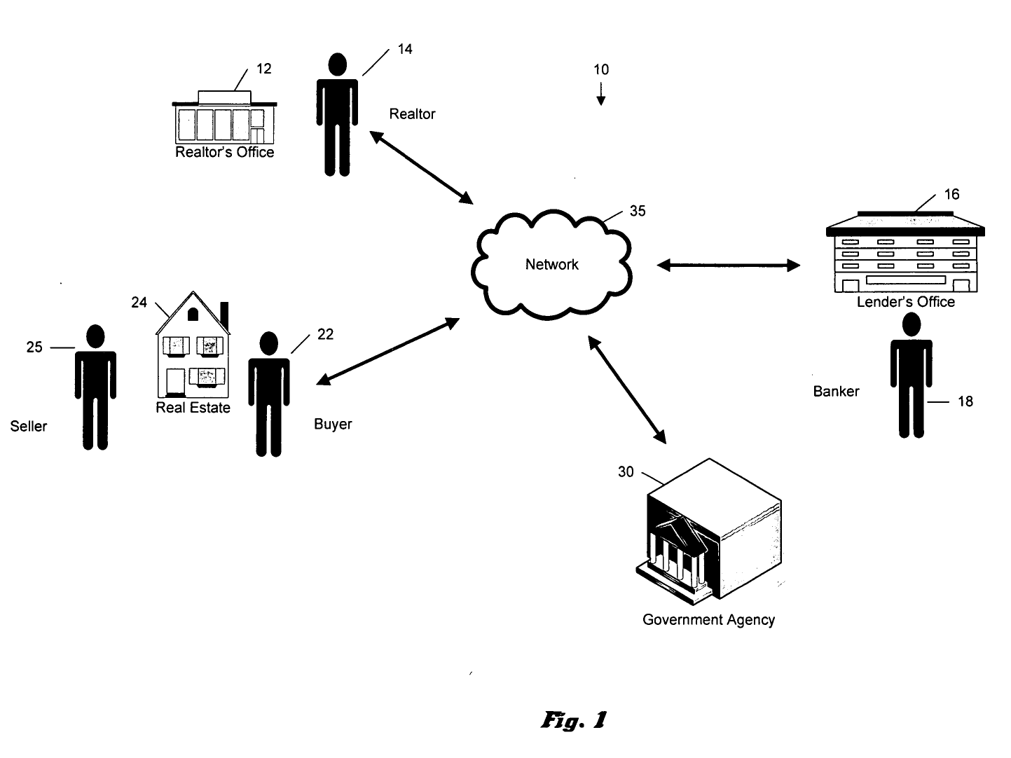

FIG. 1 illustrates an exemplary system 10 that includes a realtor's office 12 that may include therein one or more communication devices (not shown), such as a cellular phone, telephone, facsimile machine, personal digital assistant, one or more computers with a network connection, and the like. Each of the communication devices may be capable of being associated with a realtor or real estate agent 14 (such as by a telephone number, universal resource locator, email address, and the like). As a result, persons external to the realtors office 12 may communicate with the realtor 14 via the communication device or devices at the realtor's office 12, or otherwise associated with the realtor 14.

The system 10 also includes a lender's office or facility 16. In the embodiment shown, the facility 16 houses a bank or mortgage company, and agent(s) thereof. As with the realtor's office 12, the facility 16 may include one or more communication devices (not shown), such as a cellular phone, telephone, facsimile machine, computer with a network connection, personal digital assistant, and the like, that is capable of being associated with a mortgage company conducting business at the facility 16 or with a banker 18 (such as by a telephone number, universal resource locator, email address, and the like). As a result, persons external to the bank or mortgage company may communicate with the lender or banker 18 via the communication device or devices at the facility 16, or otherwise associated with the banker 18.

The system 10 also includes a buyer 22. The buyer 22 may be interested in purchasing a home or other real estate 24 from a seller 25. A government agency 30 may also participate in the system 10. The government agency 30 may be an agency that regulates banking or real estate in a particular jurisdiction, such as a state in the United States of America. As with the realtor 14 and banker 18, the buyer 22 and government agency 30 may be associated with one or more communication devices (not shown). Thus, as should be apparent from FIG. 1, the buyer 22, realtor 14, banker 18, and government agency 30 may communicate with each other in a variety of ways and through a variety of mechanisms. Generically, a network 35 is shown as providing a communication mechanism or link between the parties. The network 35 may include or encompass a variety of wired and wireless networks using protocols and equipment sufficient to support, among other things, communications using the telephone, facsimile, e-mail, and Internet communications referenced above. The network 35 may also include non-electronic forms of communication, such as traditional mail.

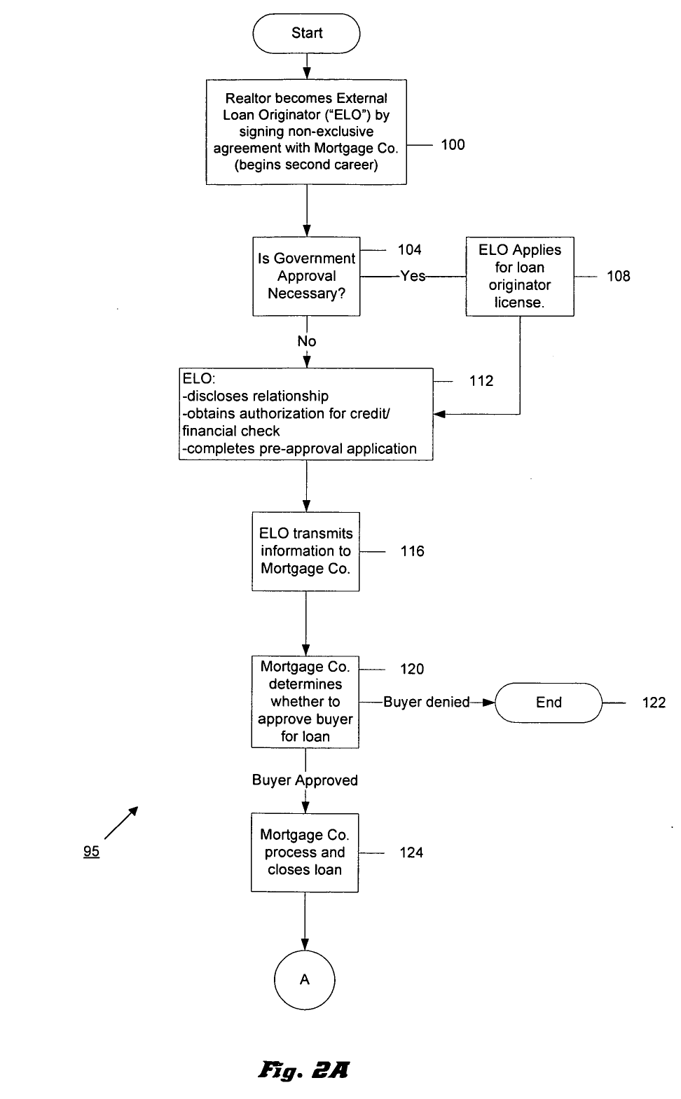

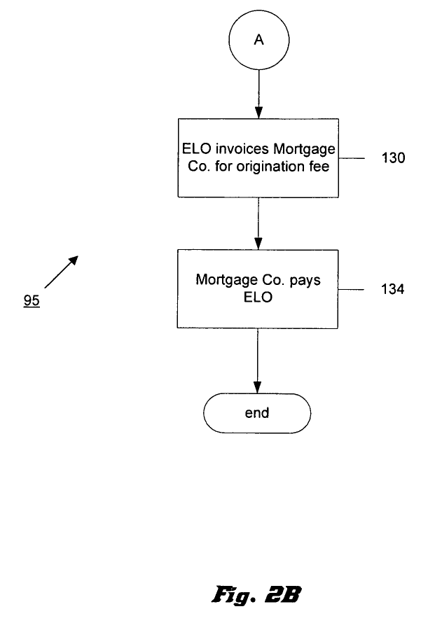

FIGS. 2A and 2B illustrate an exemplary process 95, in which various transactions may be carried out among parties such as those depicted in FIG. 1. Some and possibly all of the process 95 included in FIGS. 2A and 2B may be automated and implemented in software, hardware, and/or firmware. Alternatively or additionally, the process 95 can be carried out using traditional, non-electronic methods.

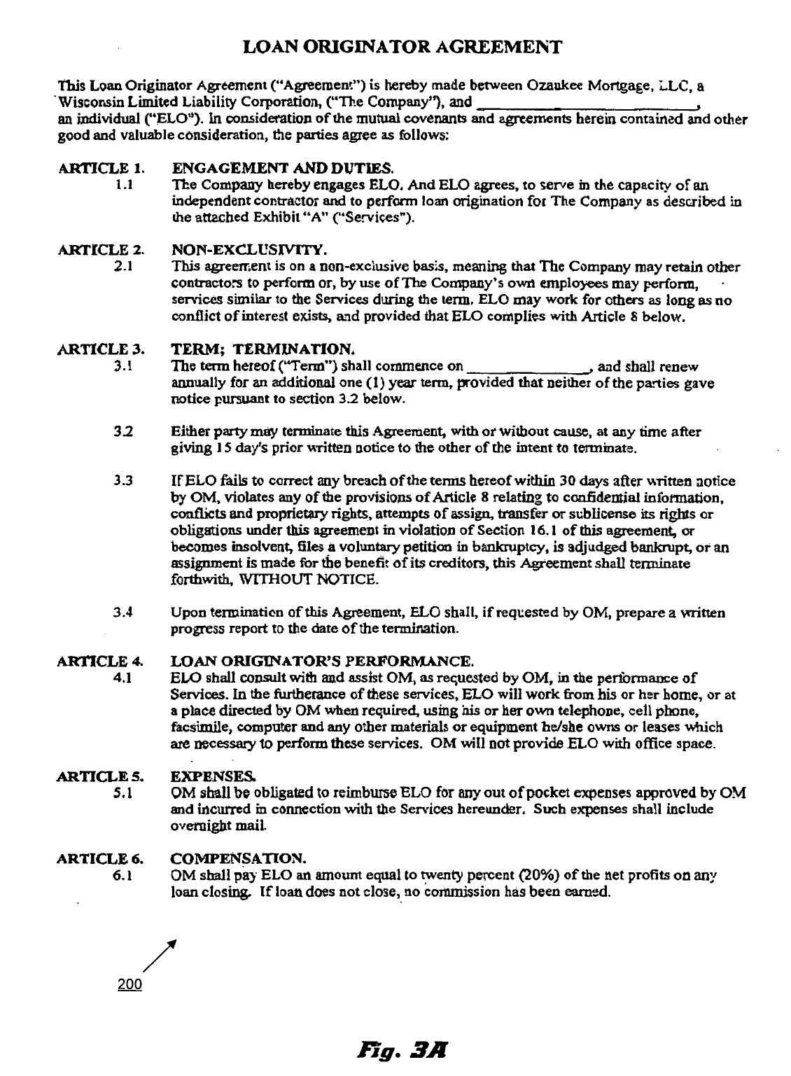

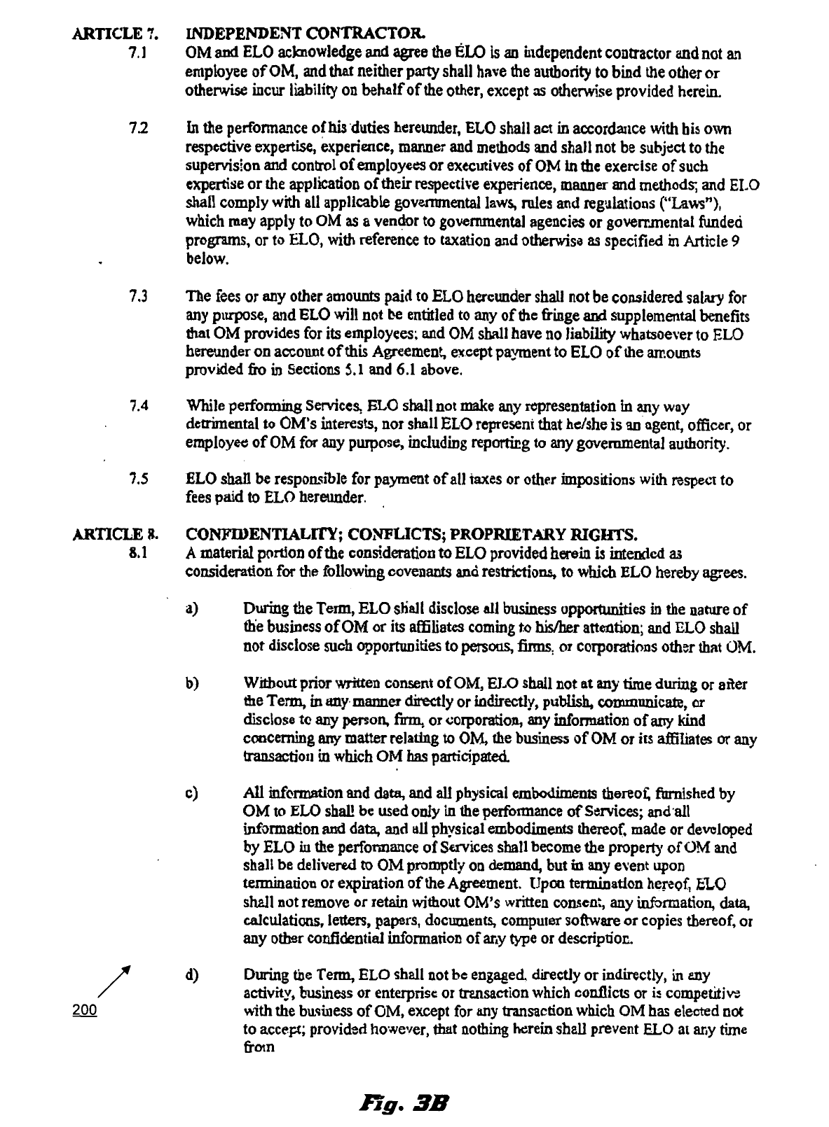

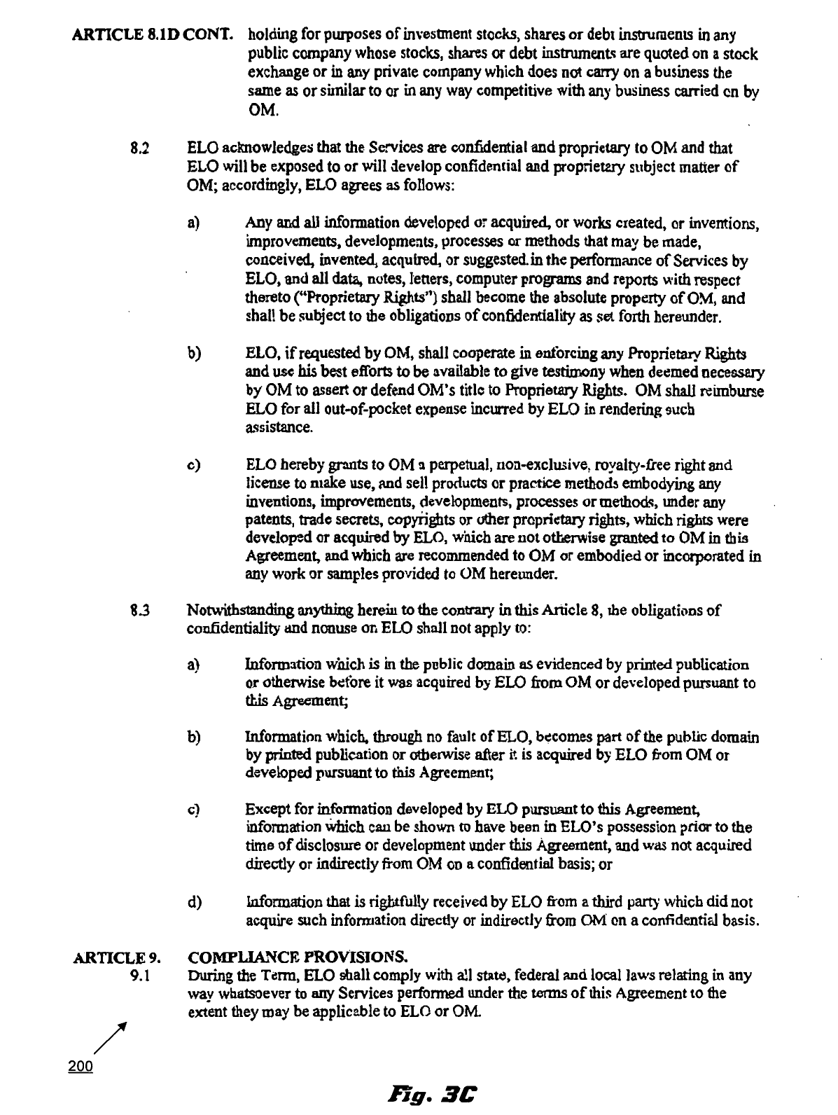

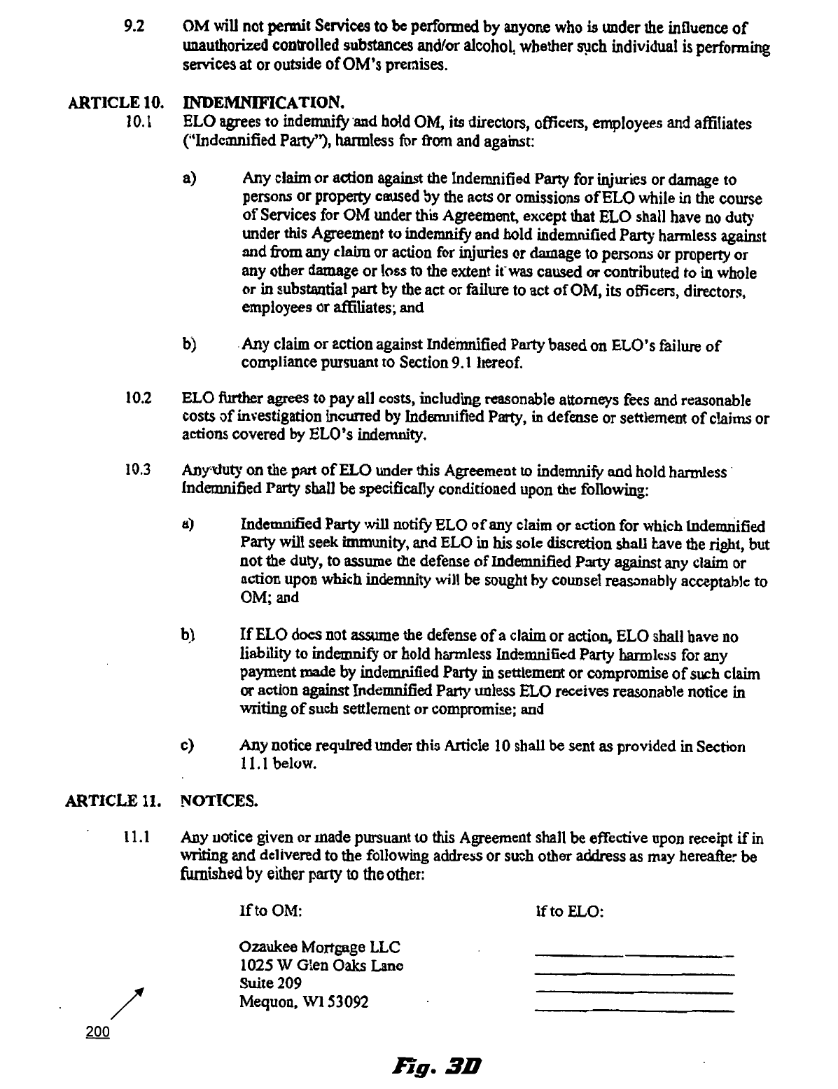

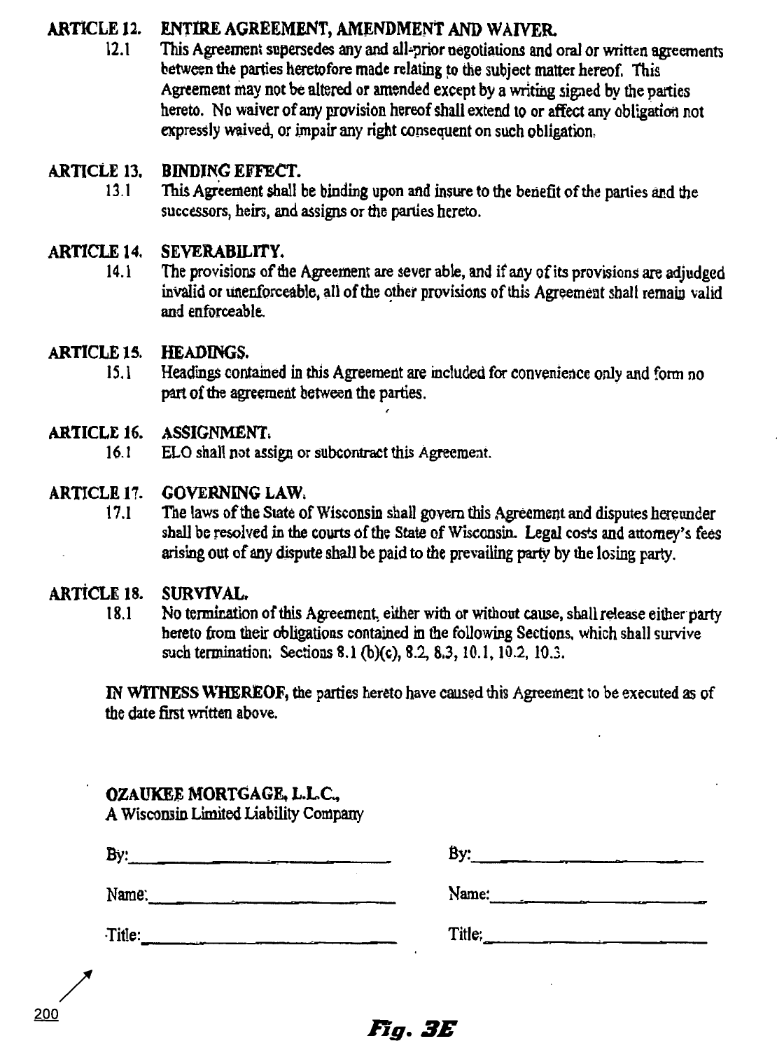

The process 95 begins at step 100, where the realtor 14 and banker 18 agree to a contractual relationship or agreement whereby the realtor 14 becomes an external loan originator (“ELO”) for the mortgage company. As with any contract, the agreement between the realtor 14 and mortgage company sets forth certain rights and obligations of the parties, for example, as described with respect to FIGS. 3A-3E below. Once a contractual relationship is established, a determination is made as to whether the realtor, now an ELO 14, must obtain any permissions or licenses from any governing agencies, such as the agency 30 (step 104). This determination may be made by the ELO 14, the banker 18, the two acting in cooperation with one another, or another appropriate entity. If approval is required, the ELO 14 applies for approval as a loan originator (step 108).

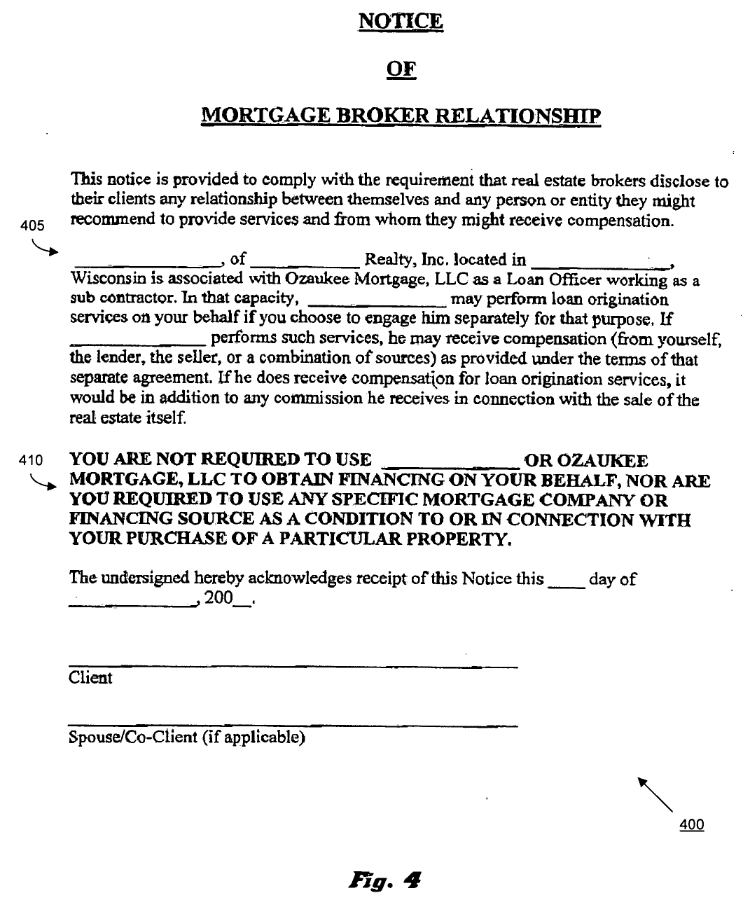

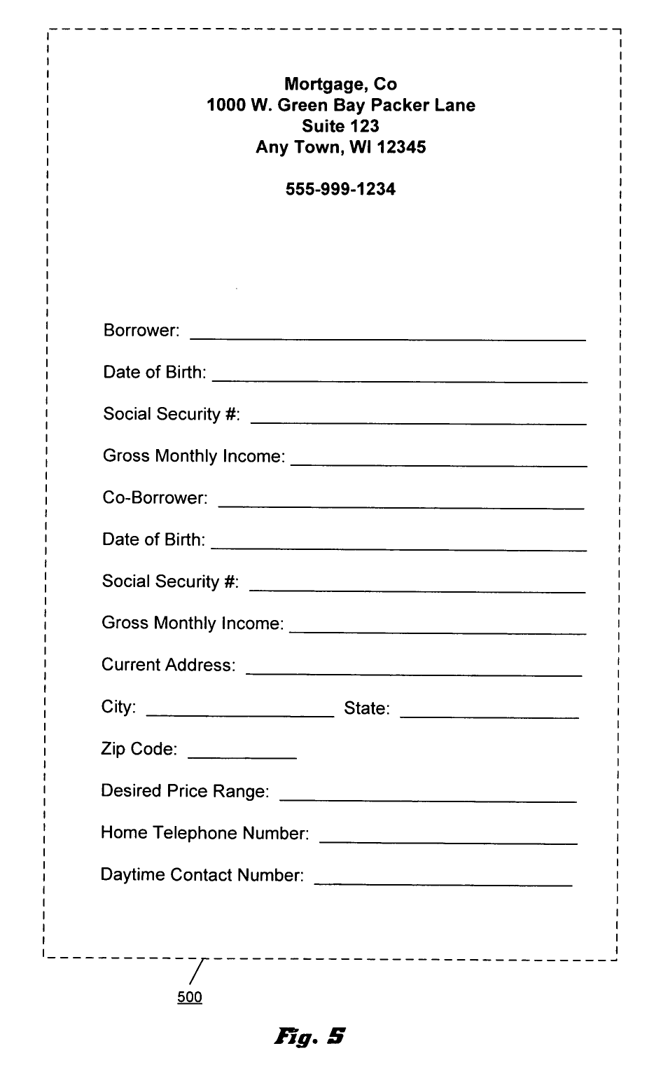

Once approval is obtained, the ELO 14 performs certain actions with the buyer 22 (step 112). In the example illustrated, the ELO 14, if required by law or regulation, discloses to the buyer 22 the ELO's relationship as an ELO of the bank or mortgage company. This disclosure informs the buyer 22 that the ELO 14 has a financial interest (e.g., in the form of an origination fee received from the banker 18) in having the buyer 22 obtain his or her loan from the mortgage company. In some embodiments, the relationship disclosure includes the buyer 22 signing a disclosure form (an example of which is shown in FIG. 4). In addition to disclosing the relationship with the mortgage company, the ELO 14 also obtains permission from the buyer 22 to have his or her financial records (such as a credit history) reviewed as part of the process of determining whether to issue a loan to the buyer 22. This permission may also take the form of a written permission form signed by the buyer 22. If permission is granted by the buyer 22, the ELO 14 queries the buyer 22 to obtain information sufficient for the banker 18 to determine whether the buyer 22 may be approved for a loan (e.g., information to make a preliminary determination of credit worthiness). The results of the queries can be recorded, for example, on a buyer information form (an example of which is shown in FIG. 5) that the ELO 14 then submits to the banker 18.

After the ELO 14 discloses the relationship with the mortgage company, obtains approval from the buyer 22 to examine the buyer's financial records, and obtains the information needed to complete the buyer information form (step 112 of FIG. 2A), the ELO 14 transmits (such as by facsimile, e-mail, EDI, etc.) the information to the banker 18 (step 116). When the banker 18 receives the information from the ELO 14, the banker 18 performs an analysis to determine whether a loan to the buyer 22 should be issued or approved (step 120). A variety of analyses may be performed on information provided by the ELO 14. Such analyses can include those currently used by financial institutions or future developed analyses. If the banker 18 determines that the buyer 22 does not meet the bank or mortgage company's criteria for obtaining a loan, the mortgage company informs the buyer (and possibly the ELO 14) of its decision and the process terminates (step 122). If, however, the buyer 22 is approved for a loan, the banker 18 processes and closes the loan, for example, using well-known techniques and procedures or future developed techniques and procedures (step 124). Appropriate funds are then routed to the seller 25. In one embodiment, upon completion of the real estate transaction or, possibly in anticipation of its successful completion, the ELO 14 invoices the bank or mortgage company for an origination fee (step 130 of FIG. 2B). Upon receiving the invoice, the bank or mortgage company pays the ELO 14 the fee set forth in the agreement initially negotiated between the ELO 14 and the banker 18 (step 134). In another embodiment, some other mutually agreed-to condition can be used to disperse funds to the ELO 14 for services rendered. For example, the mortgage company, upon closure of the loan, can automatically distribute funds to the ELO 14 without having to be invoiced.

FIGS. 3A-3E illustrate an exemplary Agreement (shown generally at 300) that can be used in step 100 of the process 95 (FIG. 2A). It should be appreciated that, in other embodiments, an agreement between the ELO 14 and the mortgage company (or banker 18) may include more or fewer provisions than those set forth in the exemplary Agreement 300. In one embodiment, the Agreement 300 requires that the ELO 14 perform certain acts and services for the mortgage company (or banker 18) in exchange for certain remuneration (for example, a percentage of a loan amount lent to the buyer) from the mortgage company. For example, as provided in articles 2 and 7 of the Agreement 300, the ELO 14 is established as a non-exclusive, independent contractor of the mortgage company. Additionally, as provided in article 4 of the Agreement 300, the ELO 14 is required to consult with a representative or employee (e.g., the banker 18) of the mortgage company in the performance of services. For example, the ELO 14 may have to consult with the banker 18 prior to, during, and/or after the services of process step 112 are performed. The Agreement 300 also establishes a compensation amount of the ELO 14 for services rendered, for example, as provided in article 6. In another article of the Agreement (article 8), confidentiality and conflict terms are disclosed. In the interest of brevity, the remaining Articles of the agreement 300 are not specifically described herein. However, the remaining Articles should be readily understood by reading and examining the figures.

FIG. 4. illustrates an exemplary relationship disclosure form 400 that, in one embodiment, can be used in step 112 of the process 95 (FIG. 2A). The form 400 generally includes identity information 405 of the ELO 14 and the mortgage company. The form 400 also includes an explicit statement 410, which states that the buyer 22 is not required to use the ELO 14 or the mortgage company to obtain financing. The relationship disclosure form 400 is perfected by the buyer signing the form 400 in a signature area 415. In other embodiments, the relationship disclosure form 400 may be arranged differently or include additional information.

FIG. 5 illustrates an exemplary buyer information form 500 (which may be a hard-copy or an electronic form) that can also be used during step 112 of the process 95 (FIG. 2A). The buyer information form 500 generally includes a field for the borrower's name, date of birth, Social Security number, and gross monthly income; a co-borrower's name, date of birth, Social Security number, and gross monthly income; the address or addresses of the borrower and co-borrower, the desired price range of the real estate the buyer is interested in, a home telephone number, and a day-time telephone number. Of course, alternative or substitute fields may be used depending upon the information that is desired by the banker 18, such as an email address of the borrower. Preferably, the form 500 does not include information regarding interest rates of a perspective loan, specific re-payment schedules of a perspective loan, and the like. These are terms that go beyond a typical pre-approval process and, therefore, should be handled directly by the banker 18 rather than the ELO 14.

Various embodiments are set forth in the following claims.

1. A method of originating a loan, the method comprising:
establishing a legally binding agreement between a real estate agent and a mortgage company to establish the real estate agent as an eternal loan originator, wherein the agreement has a set of terms, and the set of terms includes:
establishing the external loan originator as an independent contractor;
obligating the external loan originator to communicate with an agent of the mortgage company;
obligating the external loan originator to disclose the relationship with the mortgage company to a prospective buyer; and
establishing a compensation of the external loan originator by the mortgage company;
obtaining, if required by law for the external loan originator, a Federal or State loan originator license;
contacting, by the external loan originator, a prospective buyer;
disclosing, by the external loan originator, the relationship between the external loan originator and the mortgage company to the prospective buyer;
completing a pre-approval application, wherein the pre-approval application includes information sufficient to generate an initial assessment of the prospective buyer's credit worthiness, but which excludes specific loan terms; and
compensating the external loan originator upon consummation of the loan pursuant to the terms of the agreement.

2. The method of claim 1, wherein completing the pre-approval application excludes information such as interest rate, specific re-payment amounts, and the like.

3. The method of claim 1, wherein disclosing the relationship between the external loan originator and the mortgage company includes perfecting, by the perspective buyer, a notice of relationship document.

4. The method of claim 1, wherein compensating the external loan originator includes invoicing, by the external loan originator, the mortgage company.

5. The method of claim 1, further comprising establishing the legally binding agreement on an annual basis.

6. The method of claim 1, wherein establishing the legally binding agreement includes establishing a non-exclusive relationship between the external loan originator and the mortgage company.

7. The method of claim 1, wherein establishing the legally binding agreement restricts the external loan originator from engaging in transactions or activities which are competitive with the mortgage company.

8. A method of originating a loan, the method comprising:
establishing a legally binding agreement with an external licensed loan originator, wherein the agreement has a set of terms and the set of terms includes:
establishing the external loan originator as an independent contractor;
obligating the external loan originator to disclose the agreement to a prospective buyer; and
establishing a compensation of the external loan originator;
receiving a pre-approval application from the external loan originator, wherein the pre-approval application includes information sufficient to generate an initial assessment of the prospective buyer's credit worthiness, but which excludes specific loan terms; and
dispersing compensation upon consummation of the loan pursuant to the terms of the agreement.

9. The method of claim 8, wherein obligating the external loan originator to disclose the agreement to a prospective buyer includes requiring the buyer to sign a disclosure form.

10. The method of claim 8, further comprising establishing the legally binding agreement on an annual basis.

11. The method of claim 8, wherein establishing the legally binding agreement includes establishing a non-exclusive relationship with the external loan originator.

12. A method of originating a loan, the method comprising:
becoming a licensed external loan originator with a bank;
establishing an agreement with the bank, wherein the agreement has a set of terms and the set of terms includes:
becoming an independent contractor with respect to the bank;
communicating with an agent of the mortgage company; and
establishing a compensation amount to be paid by the mortgage company;
obtaining, if required by law, a Federal or State loan originator license;
disclosing a relationship with the bank with a prospective buyer;
completing a pre-approval application, wherein the pre-approval application includes information sufficient to generate an initial assessment of the prospective buyer's credit worthiness, but which excludes specific loan terms; and
receiving compensation upon consummation of the loan pursuant to the terms of the agreement.

13. The method of claim 12, wherein completing the pre-approval application excludes information such as interest rate, specific re-payment amounts, and the like.

14. The method of claim 12, wherein disclosing the relationship includes requiring the perspective buyer to perfect a notice of relationship document.

15. The method of claim 12, wherein receiving compensation upon consummation of the loan is preceded by invoicing the bank.

16. The method of claim 12, further comprising establishing the legally binding agreement on an annual basis.

17. The method of claim 12, wherein establishing the legally binding agreement includes establishing a non-exclusive relationship with the bank.
